(19) United States
(12) Patent Application Publication
(10) Pub. No.: US 2010/0305764 A1
(43) Pub. Date: Dec. 2, 2010

(54) Method and apparatus for emergency remote control of irrigation

(76) Inventors: Thomas G. Carr, Santa Ana, CA (US); Philip W. Regli, Lake forrest, CA (US)

Correspondence Address: INTELLECTUAL PROPERTY DEVELOPMENT;JACK IVAN J'MAEV, 14175 TELEPHONE AVE., SUITE L, CHINO, CA, 91710, US

(21) Appl. No.: 12/455,219

(22) Filed: May 29, 2009

(51) Int. Cl. G05D 7/06; G06F 1/12

(52) U.S. Cl. 700/284; 713/400

(57) ABSTRACT

A method and apparatus for controlling application of water in an irrigation cycle controlled by a non-centralized irrigation controller by receiving a water management command including, but not limited to a fire-shut-off command, a fire-activation-command, a drought-management-command, a pressure-management-command and a run-off-management-command. Once the command is received, parameters in the command are used to control the application of water for irrigation purposes.

### BACKGROUND

Ever since the dawn of civilization, water has been a scarce commodity. The supply of water to a modern community is distributed amongst a wide variety of users including industrial, business, recreational, residential and municipal users. These are only some examples of the types of users that all compete for water in the ordinary course of events. Many of these users can consume large quantities of water for irrigation purposes. For example, a great deal of water is used to irrigate crops, vegetation, turf or other plant life. Such plant life may be produced for sale (e.g. grain or fruit crops) or may simply be used as ground cover (e.g. grass).

In larger industrial or recreational applications, utilization of water is carefully controlled so as to minimize the costs associated with its use. For example, a golf course is a typical large recreational water consumer. In this setting, water application is usually controlled by a centralized system. These centralized systems comprise one or more controllers and a server. In these systems, there is two-way communications between the individual controllers and the server. The server, in turn, has access to a wide variety of information including, but not limited to parameters such as current soil moisture content and evapotranspiration values. In these sophisticated centralized systems, a wide range of parameters are utilized in order to determine a reasonable amount of water that should be applied to a particular type of plant life. All of these factors are then used by the server to direct the individual controllers that are responsible for the application of water to particular irrigation zones.

Accordingly, these sophisticated systems enable users to reduce the amount of water consumed and thereby result in substantial monetary savings. Unfortunately, the costs of these sophisticated systems are typically only justified where the amount of water used in a particular billing cycle is extremely large. Smaller water consumers simply cannot afford the cost of these sophisticated systems because there is simply no financial benefit in their application. A typical small water consumer may include, but is certainly not limited to, a residential user. A small water consumer may still use a less sophisticated controller. These less sophisticated controllers, which are typically referred to as non-centralized irrigation controllers, may not have access to all of the necessary parametric data and, as a consequence, may not be as effective in reducing water usage on a case by case basis.

Typically, a non-centralized irrigation controller comprises a device capable of controlling application of water to a plurality of watering zones. In this disclosure, the terms “watering zone” and “irrigation zone” are to be deemed as equivalent terms and may be used interchangeably herein. Such non-centralized irrigation controllers are typically programmed to apply irrigation to various irrigation zones in succession wherein each irrigation zone can also be programmed in terms of the quantity of water to be applied to each particular zone. This is often accomplished by setting a different duration of time during which water is applied to a particular zone. Although this is a typical means of operation, there are a wide variety of control methods employed by non-centralized irrigation controllers.

One of the problems associative with the use of many simpler non-centralized controllers on a widespread basis is that these controllers operate independent of each other and, as a result, may adversely affect the main water distribution infrastructure of a particular community. This is especially true during exigent circumstances where the demand for water may be greater than the supply or in situations where the aggregate amount of water available is simply insufficient to meet overall requirements over a particular interval of time.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for controlling the application of irrigation water during exigent circumstances or during periods of insufficient water supply;

FIG. 2 is a flow diagram that depicts alternative example methods for responding to a fire-shut-off command;

FIGS. 3 and 4 collectively comprise a flow diagram that depicts alternative example methods for responding to a fire-activation-command;

FIGS. 5 and 6 collectively comprise a flow diagram that depicts alternative example methods for responding to a drought-management-command;

FIG. 7 is a flow diagram that depicts one example method for responding to a pressure-management-command;

FIG. 8 is a flow diagram that depicts various alternative methods for shifting a peak-utilization window;

FIGS. 8A, 8B and 8C are pictorial illustrations that further illustrate various alternative methods for shifting a peak-utilization window according to a received pressure-management-command;

FIGS. 8D and 8E are flow diagrams that depict alternative example methods for responding to a run-off-management command;

FIG. 9 is a flow diagram that depicts one example method for setting a system time in order to support shifting of a peak-utilization window;

FIG. 10 is a flow diagram that depicts a further variation of the present method for conveying emergency irrigation commands to non-centralized irrigation controllers;

FIG. 11 is a block diagram that depicts alternative example embodiments of a non-centralized irrigation controller;

FIG. 12 is a pictorial illustration that depicts various example embodiments of varying types of water management command structures;

FIG. 13 is a pictorial illustration that depicts one illustrative use case where a particular water municipality is identified by a region identifier and said water municipality is further subdivided into pressure zones; and

FIG. 14 is a data flow diagram that depicts the operation of various functional modules within a non-centralized irrigation controller.

### DETAILED DESCRIPTION

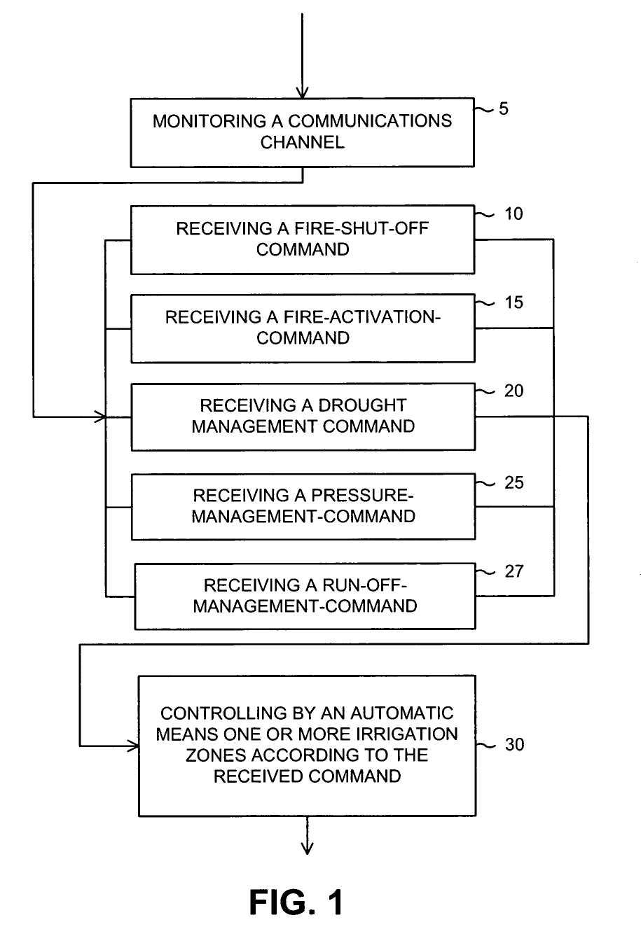

FIG. 1 is a flow diagram that depicts one example method for controlling the application of irrigation water during exigent circumstances or during periods of insufficient water supply. There are many exigent circumstances where a water delivery system within a community must be controlled in order to provide sufficient water both in terms of water volume and water pressure. For example, in a situation where a particular community is threatened by fire, the application of water for the purposes of irrigating crops, fauna or ground cover must be controlled. According to one illustrative example method, control over the application of water to an irrigation system is accomplished by monitoring a communications channel (step 5). In this illustrative method, some form of command is received by means of the communications channel. In one alternative example method, a fire-shut-off command is received (step 10) from the communications channel. In yet another example illustrative method, a fire-activation-command (step 15) is received by means of the communications channel. The fire-shut-off command and the fire-activation-command are typical of the type of commands that may be received by means of the communications channel during a fire emergency. It should be appreciated that these are merely two examples of the types of commands that may be received during a fire emergency and the claims appended hereto are not intended to be limited by this abbreviated enumeration of fire emergency commands.

In yet another example illustrative method, a drought-management-command is received (step 20) from the communications channel. In yet another illustrative method, a pressure-management-command is received (step 25) from the communications channel. A drought-management-command and a pressure-management-command are illustrative examples of the types of commands that may be received in circumstances where the supply of water is simply inadequate to meet overall demand within a community. In yet another variation of the present method, a run-off-management-command is received by means of the communications channel (step 27). A run-off-management-command is just one illustrative example of a type of command that may be used in a situation where the amount of water that must be drained away from a community must be controlled in order to avoid flooding or saturation of drainage and/or sewage systems. Accordingly, this brief enumeration of water management commands is not intended to limit the scope of the claims appended hereto.

As the reader may now appreciate, there are a wide variety of exigent circumstances which may require the distribution of a wide variety of command types in order to manage distribution of irrigation water within a community. Typically, but not necessarily, such commands will generally be used to control the application of water to various ground cover including, but not limited to, grass, shrubbery, fauna, trees, crops, and other forms of plant life. It may be appreciated that, during exigent circumstances, the priority of water utilization shifts away from irrigation to other applications, for example for use in fire fighting. In other exigent circumstances, control of irrigation may be necessary to provide pressure management or to reduce the flow in drainage or sewage systems. However, there are many types of exigent circumstance and such variations that may be considered within the scope of the claims appended hereto are contemplated herein. In a continuing step of this example method, one or more irrigation zones are controlled by an automatic means according to the received command (step 30).

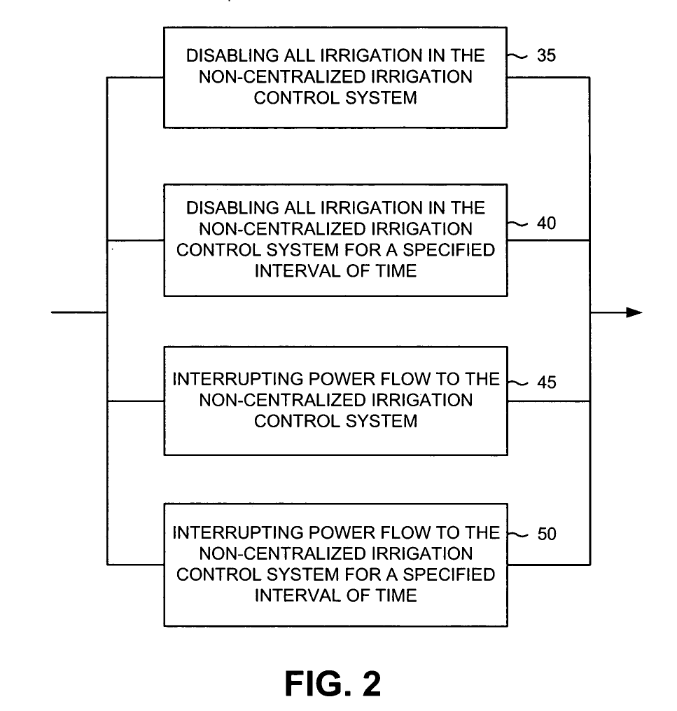

FIG. 2 is a flow diagram that depicts alternative example methods for responding to a fire-shut-off command. In one illustrative use case, a non-centralized irrigation controller is utilized to control irrigation in a residential setting. Of course, the claims appended hereto are not intended to be limited in their scope to any particular application venue. It should be appreciated that a non-centralized irrigation controller may be utilized in commercial or municipal applications or in agricultural applications. And even this list of applications is not complete and is not intended to limit the scope of the claims appended hereto. In one illustrative alternative method, all irrigation in a non-centralized irrigation controller is disabled when a fire-shut-off command is received (step 35). In yet another variation of the present method, all irrigation in a non-centralized irrigation controller is disabled for a specified interval of time when a fire-shut-off command is received (step 40). It should be appreciated that, in this variation of the present method, the fire-shut-off command comprises a parameter that specifies the interval of time that irrigation should be disabled. Typically, but not necessarily, the two variations of the present method described supra are implemented within the non-centralized irrigation controller. However, there are at least two additional variations of the present method wherein disabling the flow of water for irrigation purposes in response to a fire-shut-off command is accomplished by interrupting power to the non-centralized irrigation controller (step 45). In another variation of the present method, power is interrupted to the non-centralized irrigation controller for a particular interval of time (step 50). It should be appreciated that a typical non-centralized irrigation controller requires some external power, which is then applied to actuators in order to enable the flow of water during an irrigation cycle. It should further be appreciated that when the power to the non-centralized irrigation controller is interrupted in response to a fire-shut-off command, then the non-centralized irrigation controller is no longer capable of enabling the actuators in order to allow water to be applied by an irrigation system.

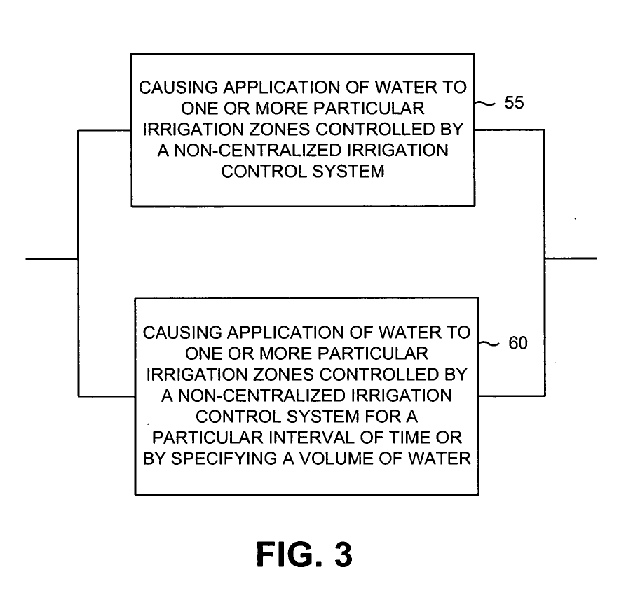

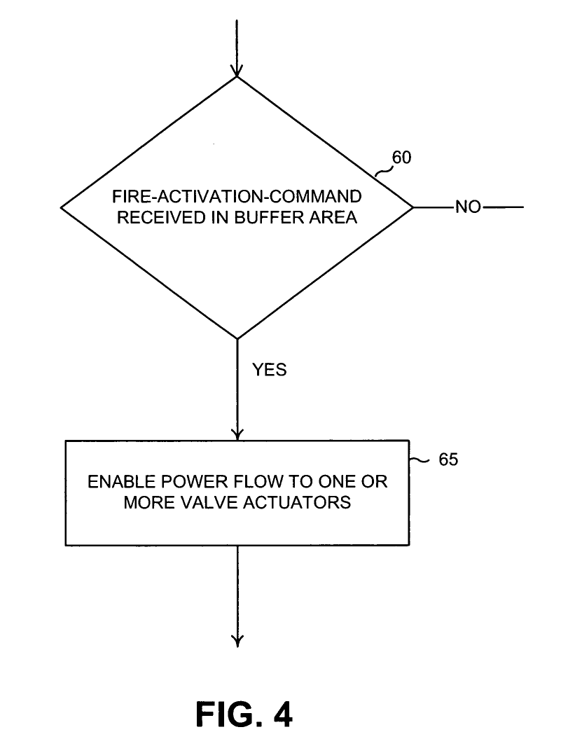

FIGS. 3 and 4 collectively comprise a flow diagram that depicts alternative example methods for responding to a fire-activation-command. It should be appreciated that in many situations, especially in residential or commercial venues that are adjacent to undeveloped land such as scrub, bush or forest, there exists the grave potential for fire to spread from the surrounding undeveloped land to the adjacent structures. In this type of a situation, it may be advantageous to actually apply irrigation water to particular irrigation zones in efforts to establish a fire break. Accordingly, one example variation of the present method provides for application of water to one or more particular irrigation zones that are controlled by a non-centralized irrigation controller (step 55). In yet another illustrative variation of the present method, water is applied to one or more particular irrigation zones that are controlled by a non-centralized irrigation controller wherein such application is limited to a particular interval of time or to a particular amount of water volume (step 60). It may be further appreciated that, according to this variation of the present method, a fire-activation-command comprises a parameter that defines the amount of time that water should be applied to a particular irrigation zones. In yet a different variation of the present method, a fire-activation-command comprises a parameter that defines the volume of water that should be applied to particular irrigation zone. In this case, the non-centralized irrigation controller would require additional parameters, for example the volume of water that is applied to a particular irrigation zone per unit time interval. This, accordingly, may be programmed into the non-centralized irrigation controller when it is installed, or during periodic maintenance. In yet another variation of the present method, a non-centralized irrigation controller will respond to a fire-activation-command only when the non-centralized irrigation controller is disposed in a fire buffer area (step 65). When the fire-activation-command is received in a fire buffer area, then one or more valve actuators are enabled (step 70) by the non-centralized irrigation controller for such irrigation zones that are programmed for the purpose of establishing a fire break. Accordingly, a non-centralized irrigation controller will accept programming parameters in order to identify which irrigation zones should be activated in the event a fire-activation-command is received.

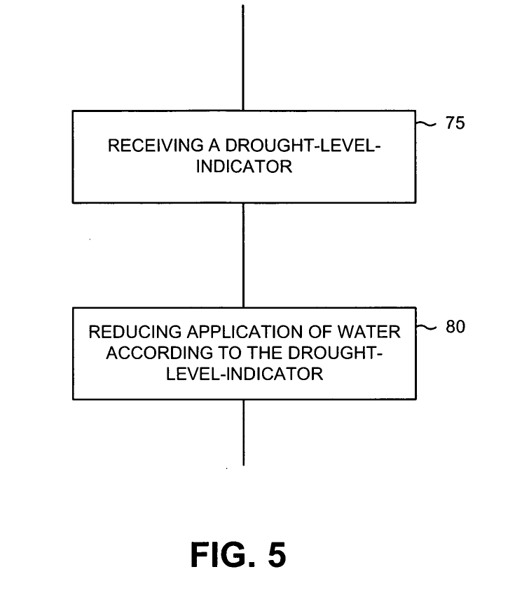

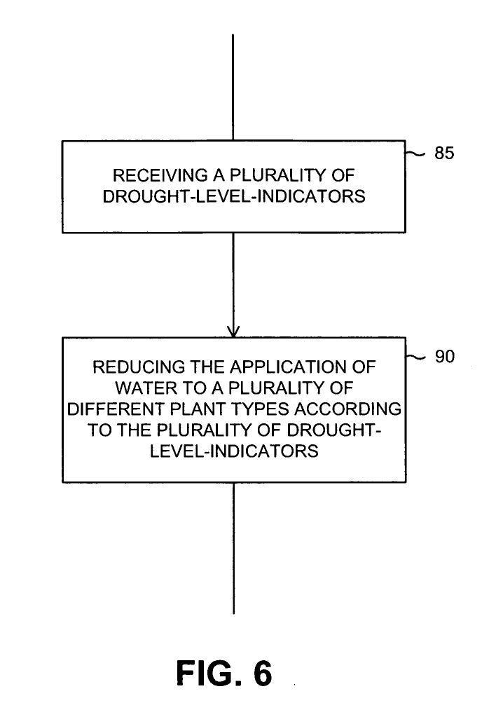

FIGS. 5 and 6 collectively comprise a flow diagram that depicts alternative example methods for responding to a drought-management-command. In a situation where water must be rationed, or is otherwise in short supply, one variation of the present method provides for receiving a drought-level-indicator by means of the communications channel. Accordingly, in one illustrative variation of the present method, such a drought-level-indicator is received (step 75) and the amount of water to be applied during an irrigation cycle is reduced according to the received drought-level-indicator (step 80). It should also be appreciated that, according to yet another illustrative variation of the present method, a plurality of drought-level-indicators are received by means of the communications channel (step 85). As such a particular drought-level-indicator will typically correspond to a different type of plant life. As such, this variation of the present method provides for reducing the amount of water to be applied to different types of plants according to a particular corresponding drought-level-indicator (step 90). In this manner, it is possible to maintain the life of a particular type of plant where various plants may be more drought tolerant than other plants.

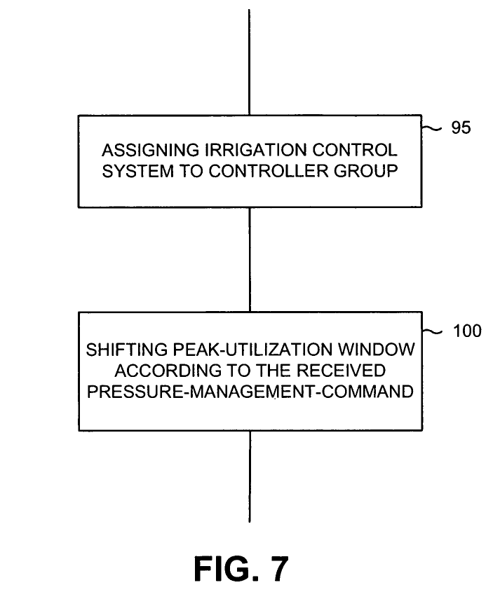

FIG. 7 is a flow diagram that depicts one example method for responding to a pressure-management-command. It should be appreciated that, especially in large metropolitan areas or in areas where the water supply infrastructure may be insufficient to supply all demand in a particular utility region, there may be the need to manage irrigation in order to maintain a minimum amount of water pressure within the water delivery infrastructure. Accordingly, one example variation of the present method provides for assigning a non-centralized irrigation controller to a controller group (step 95). This may be accomplished by a variety of means, for example by programming each controller within a group of controllers with an ordinal identifier. In yet another variation of the present method, global positioning information is used in order to establish the position of a particular controller within a water delivery infrastructure. In this variation of the present method, the global positioning information is used for assigning a particular controller to a particular group of controllers according to the coordinates of that particular controller within a coordinate grid associated with the water delivery infrastructure. It should be appreciated that the claims appended hereto are not to be limited in scope to any particular means of assigning a non-centralized irrigation controller to a particular group of such controllers. Once the non-centralized irrigation controller has been assigned to a particular group of controllers, then each controller in a particular group will receive a command causing all of the irrigation controllers in that particular controller group to shift their peak-utilization window according to such received pressure-management-command (step 100).

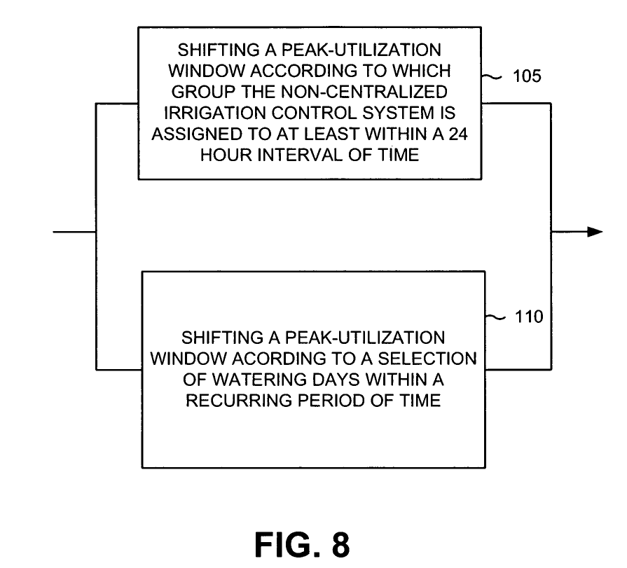

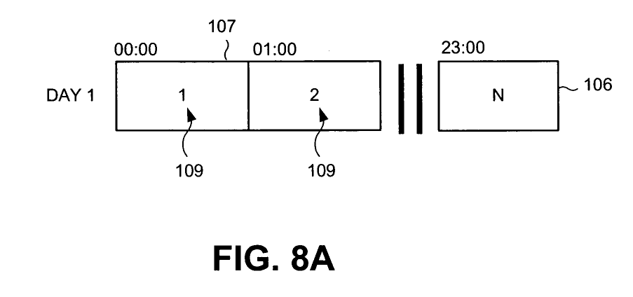

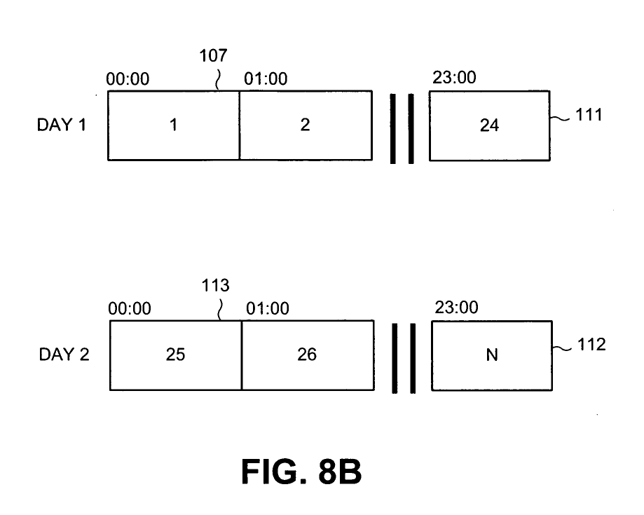

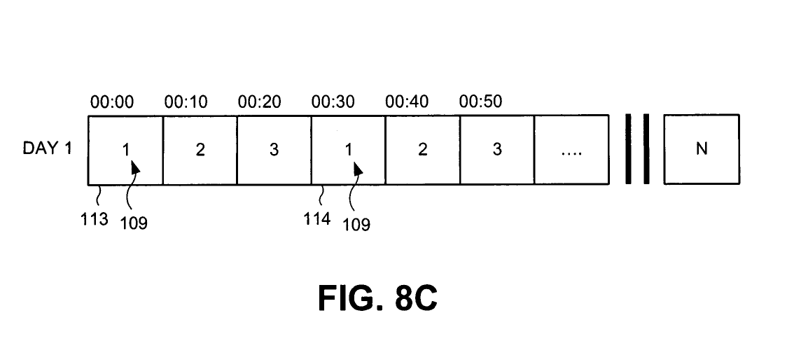

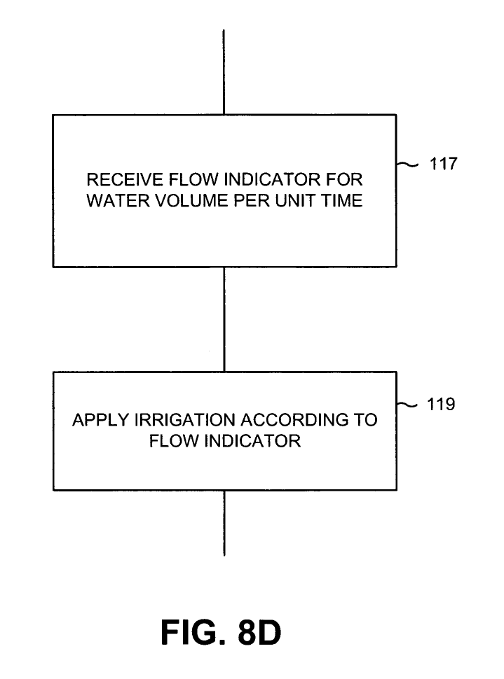

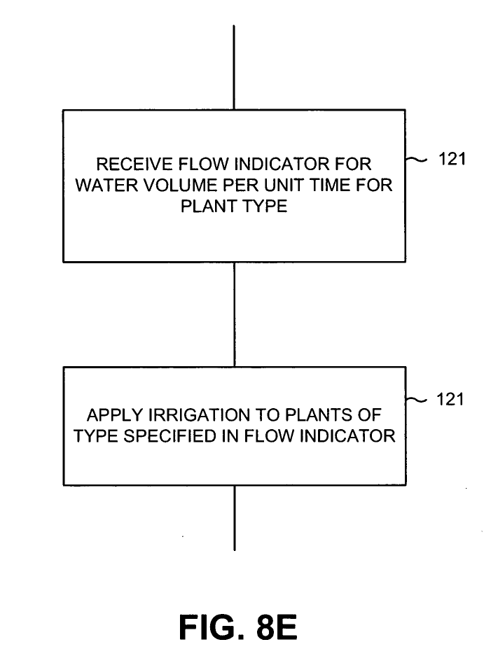

FIG. 8 is a flow diagram that depicts various alternative methods for shifting a peak-utilization window. FIGS. 8A, 8B and 8C are pictorial illustrations that further illustrate various alternative methods for shifting a peak-utilization window according to a received pressure-management-command. In one alternative variation of the present method, a peak-utilization window is shifted according to which group a non-centralized irrigation controller is assigned to and the peak-utilization window is assigned to a particular interval of time within a 24-hour time interval (step 105). This is also depicted in FIG. 8A wherein a 24-hour period 106 is partitioned into hourly time intervals 107 and a particular controller group 109 is then assigned to one of the hourly time intervals 107 within the 24-hour period 106.

In yet another alternative variation of the present method, a peak-utilization window is shifted according to a selection of watering days within a recurring period of time (step 110). For example, a selection of watering days may include seven days (e.g. one day for each day of a calendar week). However, any selection of watering days may be used as a wide variety of such varied selections are contemplated herein and are to be considered within the scope of the claims appended and the scope of the claims appended hereto is not to be limited to any particular selection of watering days.

In one illustrative use case, it may be advantageous for one utility district to select a three-day selection of watering days. Another utility district may select a different selection of watering days within a recurring period of time. Again, there are a wide variety of possibilities for the selection of a particular number of watering days within a recurring period of time. FIG. 8B further illustrates one illustrative use case where a two-day (111, 112) selection of watering days is organized into 48 hourly watering intervals 113. In this illustrative use case, a particular group of controllers will perform their irrigation function on alternating days. It should be appreciated that, although FIGS. 8A and 8B illustrate that a 24-hour period may be partitioned into hourly time intervals, the scope of the claims appended hereto is not intended to be limited in this manner. For example a 24-hour interval of time may be partitioned into ten minute time intervals, but any other convenient interval of time may be used.

FIG. 8C depicts yet another novel illustrative use case wherein particular groups of non-centralized irrigation controllers are assigned to a plurality of different time intervals within a particular recurring period of time. As depicted in FIG. 8C, assignment of a particular group of non-centralized irrigation controllers 109 to different intervals of time within the recurring period of time is one example where receipt of a pressure-management-command may be used in an alternative capacity, for example in managing run-off that occurs as a result of excessive irrigation. In this illustrative use case, a particular group of controllers 109 will apply water for a 10 minute interval of time and then allow the water to soak into the soil that is the subject of the irrigation. Subsequent watering can then be accomplished at a later point in time according to the next particular time interval within the same recurring period of time. For example, in FIG. 8C, a particular group of irrigation controllers identified by an ordinal value of “1” 109 is assigned to an interval at 00:00 (113) and 00:30 (114). This would mean that irrigation controllers identified by the ordinal value of “1” would apply water at midnight and at 12:30 AM. Again this is just one example variation of the present method and any examples in terms of assignment of the particular group of irrigation controllers to any particular interval within any particular recurring period of time are presented merely for the purpose of clarification of the present method and are not intended to limit the scope of the claims appended hereto. Again, the scope of the claims appended hereto are not to be limited to any particular partitioning arrangement within a 24-hour interval of time or any particular selection of watering days within a recurring period of time as may be illustrated as illustrative use cases in FIG. 8A, 8B or 8C.

FIGS. 8D and 8E are flow diagrams that depict alternative example methods for responding to a run-off-management command. According to one illustrative example method, a flow indicator for an amount of water per unit time is received (step 117) as part of the run-off-management command. In this illustrative example method, irrigation is applied according to the flow indicator (step 119). It should be appreciated that the flow indicator, according to this illustrative method, is used to limit the application of water to a particular irrigation zone in order to minimize run off, thereby preventing waste of irrigation water and reducing the burden on drainage and/or sewage systems. In this situation, a non-centralized irrigation controller would use the flow indicator along with other information, for example an amount of water applied per unit time interval for an irrigation zone, in order to control the duration of watering for a particular irrigation zone under control of the non-centralized irrigation controller. Accordingly, a non-centralized irrigation controller embodying the method described herein, in one illustrative use case, would stagger application of water over a longer period of time in order to comply with the flow indicator received in a run-off-management command. In yet another example alternative method, responding to a run-off-management command comprises receiving the flow indicator for a water volume per unit time for a particular type of plant (step 121). In a like manner to that described supra, irrigation is applied to varying types of plants according to one or more flow indicators that correspond to said different types of plants (step 123).

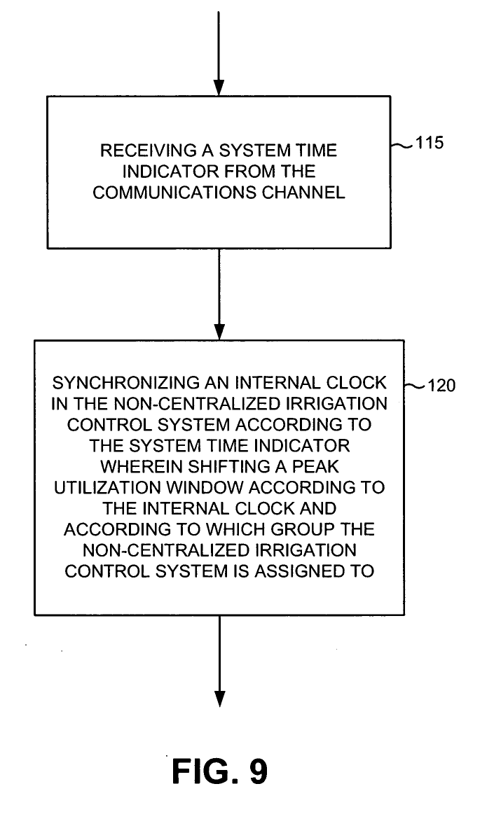

FIG. 9 is a flow diagram that depicts one example method for setting a system time in order to support shifting of a peak-utilization window. According to this illustrative variation of the present method, a system time indicator is received from the communications channel (step 115). Once the system time indicator is received, it is then used to synchronize an internal clock in the non-centralized irrigation controller (step 120). Accordingly, by synchronizing the internal clock to the system clock, a plurality of non-centralized irrigation controllers can operate under a centralized guidance for shifting a peak-utilization window according to their internal clocks because said internal clocks are synchronized with a central system clock.

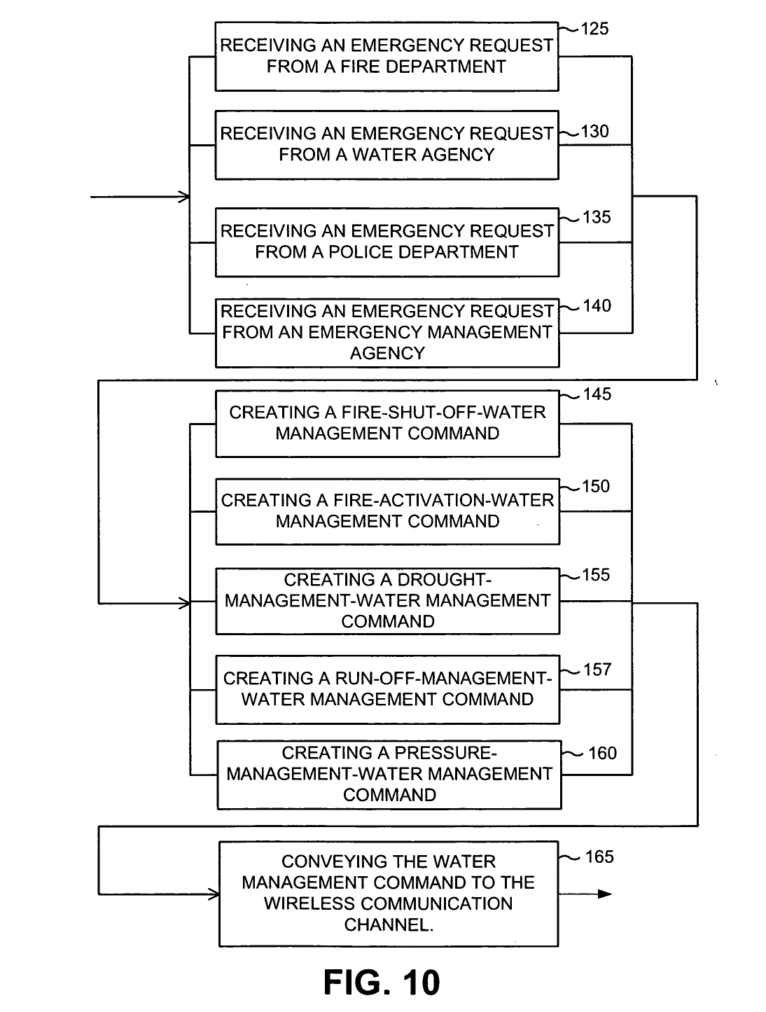

FIG. 10 is a flow diagram that depicts a further variation of the present method for conveying emergency irrigation commands to non-centralized irrigation controllers. According to this variation of the present method, a command is conveyed to one or more non-centralized irrigation controllers using a communications channel. In this variation of the present method, a request for issuance of such a command is first received by a system from a variety of sources. An emergency request, according to one variation of the present method, is received from a fire department (step 125). In yet another illustrative variation of the present method, an emergency request is received from a water agency (step 130). And in yet another variation of the present method, an emergency request is received from a police department (step 135). In yet another illustrative variation of the present method, an emergency request is received from an emergency management agency (step 140). Although such requests are typically received from public agencies, the claims appended hereto are not intended to be limited in this regard. It is entirely conceivable that a request for issuance of an emergency irrigation command may be received from any source, be at a public agency or otherwise.

Depending upon the type of emergency request received, a variety of different emergency irrigation commands may be created. In one illustrative variation of the present method, a fire-shut-off water management command is created (step 145). In yet another variation of the present method, a fire-activation water management command is created (step 150). In yet another illustrative variation of the present method, a drought-management water management command is created (step 155). In yet another illustrative variation of the present method, a run-off management command is created (step 157). In yet in another alternative variation of the present method, a pressure-management water management command is created (step 160). Irrespective of the type of command created, this variation of the present method provides for conveying the water management command to the communications channel (step 165).

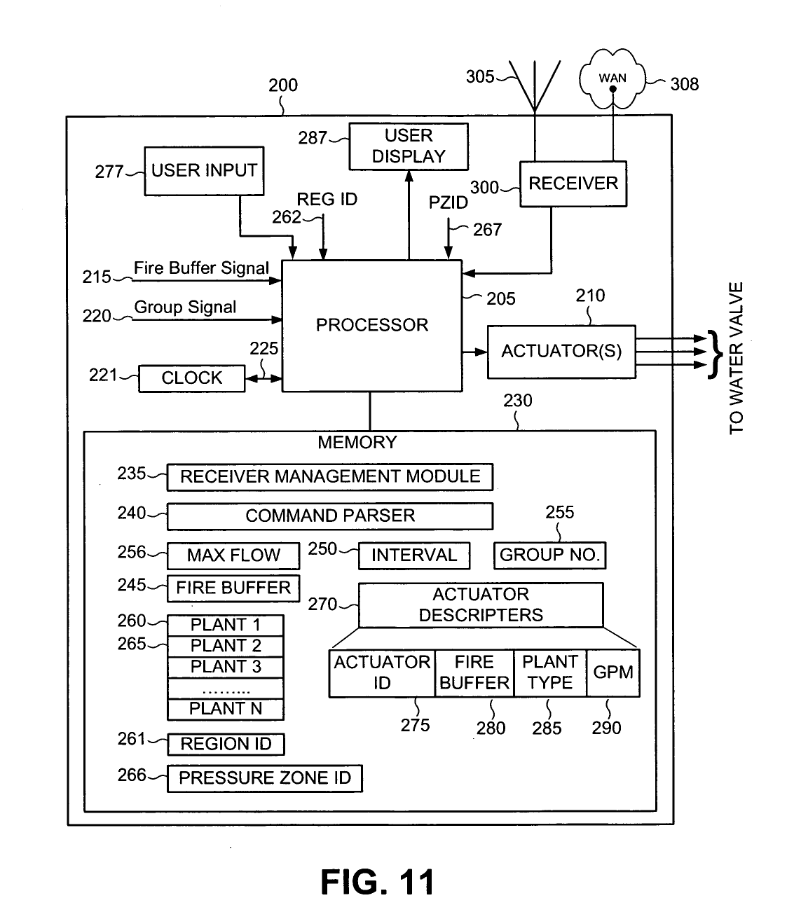

FIG. 11 is a block diagram that depicts alternative example embodiments of a non-centralized irrigation controller. In one example embodiment, a non-centralized irrigation controller 200 comprises one or more processors 205, a memory 230, a receiver 300, and one or more actuators 210. It should be appreciated that the receiver 300, according to various alternative example embodiments, comprises either a wireless receiver or a network interface. Accordingly, in those embodiments where the receiver 300 comprises a wireless receiver, an antenna 305 is also included in the non-centralized irrigation controller 200. It should further be recognized that the antenna 305, according to alternative illustrative embodiments, is disposed either within the non-centralized irrigation controller or is disposed external there to. In those alternative example embodiments where the receiver comprises a network interface, such a network interface comprises at least one of a wired and wireless network interface. In either case, connectivity 307 to a network 308 enables the processor 205 to receive water management commands according to the methods taught herein.

Also included in various example alternative embodiments of a non-centralized irrigation controller 200 are one or more functional modules. A functional module is typically embodied as an instruction sequence. An instruction sequence that implements a functional module, according to one alternative embodiment, is stored in the memory 230. The reader is advised that the term “minimally causes the processor” and variants thereof is intended to serve as an open-ended enumeration of functions performed by the processor 205 as it executes a particular functional module (i.e. instruction sequence). As such, an embodiment where a particular functional module causes the processor 205 to perform functions in addition to those defined in the appended claims is to be included in the scope of the claims appended hereto.

The functional modules (i.e. their corresponding instruction sequences) described thus far that enable irrigation control according to the present method are, according to one alternative embodiment, imparted onto computer readable medium. Examples of such medium include, but are not limited to, random access memory, read-only memory (ROM), programmable read only memory, flash memory, electrically erasable programmable read only memory, compact disk ROM (CD ROM), floppy disks, hard disk drives, magnetic tape and digital versatile disks (DVD). Such computer readable medium, which alone or in combination can constitute a stand-alone product and can be used to convert a general-purpose computing platform into a device capable of controlling irrigation according to the techniques and teachings presented herein. Accordingly, the claims appended hereto are to include such computer readable medium imparted with such instruction sequences that enable execution of the present method and all of the teachings herein described.

In this example embodiment, instruction sequences stored in the memory 230 include a receiver management module 235 and a command parser 240. The receiver management module 235, when executed by the processor 205, minimally causes the processor 205 to receive a water management command including, but not limited to, a fire-shut-off command, a fire-activation command, a drought-management command, a pressure-management command, a run-off-management command and a time command. The command parser 240, when executed by the processor 205, minimally causes the processor 205 to control actuator outputs 210 in response to a received water management command.

In another alternative example embodiment, the memory 230 is used to store particular variables that are potentially necessary to properly respond to various water management commands that may be received by a non-centralized irrigation controller 200. For example, in one illustrative alternative embodiment, the memory 230 is used to store a fire buffer Boolean variable 245. The Boolean variable 245 is used to indicate if the non-centralized irrigation controller is situated in a fire buffer zone. In yet another alternative example embodiment, the memory 230 is used to store a group number 255. The group No. 255 comprises a memory variable that is used to indicate which group a particular non-centralized irrigation controller 200 is assigned to. In yet another alternative example embodiment, the memory 230 is used to store an interval variable 250. The interval variable 250 is used by the processor 205, as it executes various instruction sequences, in order to determine which interval during a recurring period of time that irrigation should be performed. And in yet another alternative example embodiment, the memory 230 is used to store one or more drought level indicators 260. Where more than one such drought level indicators are stored in the memory 230, a different such drought level indicator 265 is used for different types of plant life. In yet another alternative example embodiment, the memory 230 is used to store one or more actuator descriptors 270. In one such alternative example embodiment, an actuator descriptor 270 includes an actuator identifier 275, which is typically, but not necessarily an ordinal value. In yet another alternative example embodiment, an actuator descriptor 270 further includes a fire buffer Boolean value 280. The fire buffer Boolean value 280 is used to indicate if a particular actuator is used to service a fire buffer zone. According to yet another illustrative alternative embodiment, the actuator descriptor 270 further includes a plant type indicator 285. In this illustrative alternative embodiment, this plant type indicator 285 is used in conjunction with a particular corresponding drought level indicator 265 in order to determine the amount of water to be applied in response to a drought-management command. In one alternative example embodiment, a non-centralized irrigation controller 200 also includes a maximum flow variable 286 that is stored in the memory 230.

And in yet another alternative example embodiment, the actuator descriptor 270 further includes a flow rate indicator 290 which is used to indicate the amount of water that will be applied per-unit time when the actuator is active. According to the figure, one such method for indicating a flow rate is in “gallons per minute” (GPM). It should be appreciated that this is merely an example and flow rate may be specified in any suitable manner. In yet another alternative example embodiment, a non-centralized controller 200 further includes a clock 221. The clock 221 is first synchronized 225 to a system time by the processor 205 as it executes the appropriate instruction sequences in order to receive a time command, the process for which is described in greater detail infra.

Some example alternative embodiments of a non-centralized irrigation controller 200 further include a user input 277 and a user display 287. It should be appreciated that the user input 277 and the user display 287 are used by the processor 205 for the purposes of obtaining input from a human user and to display information to said human user. And in at least one example alternative embodiment, a non-centralized irrigation controller 200 further includes a fire buffer signal 215, which is used to indicate that a particular non-centralized irrigation controller 200 is disposed in a fire buffer zone and should respond to fire-activation commands as described within this disclosure. In yet another alternative example embodiment, a non-centralized irrigation controller 200 further includes a group signal indicator 220. The group signal indicator 220 is used by the processor, as it executes various instruction sequences, to determine to which group of non-centralized irrigation controllers a particular non-centralized irrigation controller is assigned to. It should be appreciated that both the fire buffer signal 215 and the group signal 220 may in fact be omitted in embodiment where the processor 205 receives its information by means of the user input 277. In order to determine within which region or within which pressure zone a particular non-centralized irrigation controller 200 is disposed, one alternative example embodiment of a non-centralized irrigation controller 200 includes a region identifier input 262. And in yet another alternative example embodiment, a non-centralized irrigation controller 200 also includes a pressure zone identifier input 267. These two inputs, respectively, are used by the processor 205, as it executes various instruction sequences to determine at least one of which region it is situated within and in which pressure zone it is situated within.

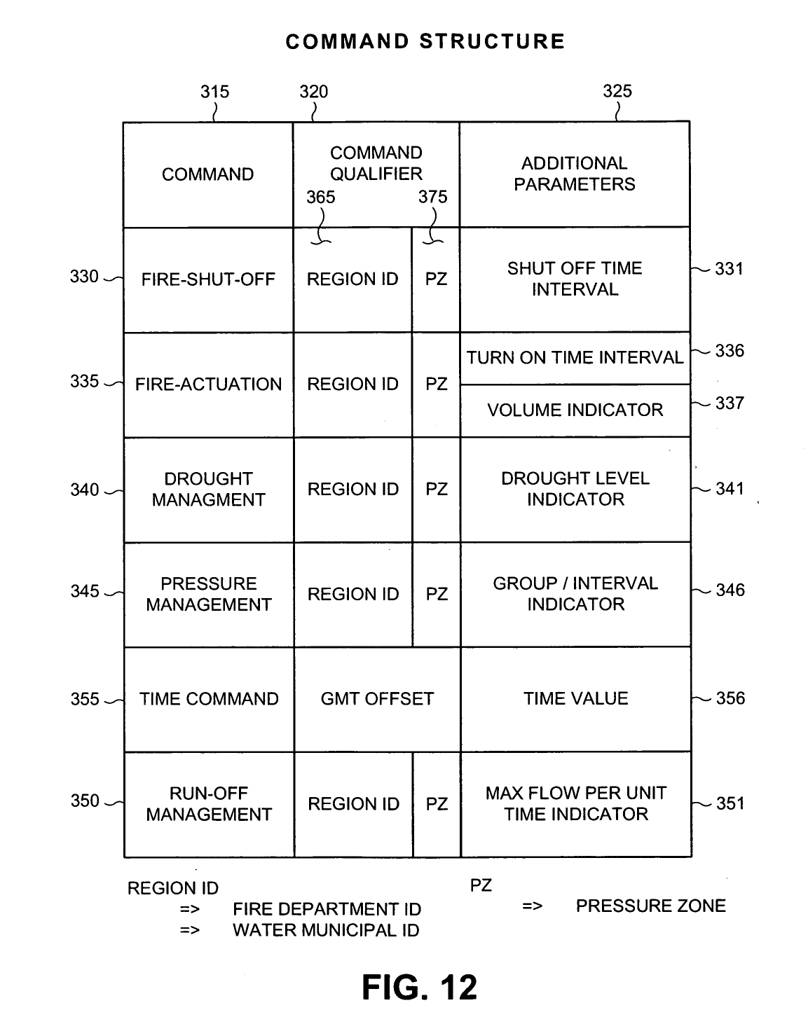

FIG. 12 is a pictorial illustration that depicts various example embodiments of varying types of water management command structures. It should be appreciated that the examples depicted in FIG. 12 are presented merely for the purpose of clarifying the present disclosure and are not intended to limit the scope of the claims appended hereto. According to one example embodiment, a water management command comprises a command field 315 and a command qualifier field 320. In yet another illustrative embodiment, a water management command further comprises additional parameters 325, which may vary according to the type of water management command received by a non-centralized irrigation controller 200. According to one example embodiment, a fire-shut-off command comprises a command field 315 which is set to a value in order to distinguish the command as a fire-shut-off command 330. In this example embodiment, the fire-shut-off command 330 further comprises a command qualifier 320, which in an alternative example embodiment comprises at least one of a region identifier 365 and a pressure zone identifier 375. In yet another alternative example embodiment, the fire-shut-off command 330 further comprises additional parameters 325. In one such alternative embodiment, the additional parameters 325 comprise a shut off time interval 331. Typically, the shut off time interval would be used to specify how long irrigation should be disabled during a fire emergency.

FIG. 12 further illustrates one alternative embodiment of a fire-activation command. Typically, a fire-activation command is used to enable irrigation in fire buffer zones. Accordingly, the structure of a fire-activation command, at least according to this illustrative embodiment, comprises a command field 315 which is set to a value in order to distinguish the command as a fire-activation command 335. In this alternative example embodiment, the fire-activation command 335 further comprises a command qualifier 320 which includes at least one of a region identifier 365 and a pressure zone identifier 375. In yet another alternative example embodiment of a fire-activation command 335, the fire-activation command 335 includes additional parameters 325. According to this alternative example embodiment, the additional parameters 325 include at least one of a turn on time interval 336 and a volume indicator 337. In cases of fire emergency where irrigation is to be enabled in a particular fire buffer zone, these additional parameters allow control over the length of time (336) that irrigation should be enabled to a fire buffer zone or control over the amount of water (337) to be applied to a fire buffer zone.

FIG. 12 also illustrates one example embodiment of a drought-management command 340. Typically, a drought-management command is used to reduce irrigation levels in times where water supply is decreased, e.g. in a drought condition. It should be appreciated that a drought-management command may be used during other exigent circumstances, for example where the quantity of available water falls below a critical threshold, and this may occur even when there is no drought condition. For example, a critical water supply conduit may fail causing such conditions. According to this example embodiment, a drought-management command 340 comprises a command field 315 which is set to a value in order to distinguish the command as a drought-management command 340. This example embodiment of a drought-management command 340 further comprises a command qualifier 320, which according to this alternative example embodiment, comprises at least one of a region identifier 365 and a pressure zone identifier 375. In yet another alternative embodiment of a drought-management command 340, the drought-management command 340 further comprises a drought level indicator 341 as an additional parameter 325. It should be appreciated that yet another alternative example embodiment provides for a plurality of drought level indicators that correspond to different types of plant life. In this alternative embodiment, this plurality of drought level indicators is included in the additional parameters 325.

FIG. 12 illustrates one alternative example embodiment of a pressure-management command 345. In this example embodiment of a pressure-management command 345, the command comprises a command field 315 which is set to a value in order to distinguish the command as a pressure-management command 345. This example embodiment of a pressure management command further includes a command qualifier 320. According to various alternative example embodiments, a pressure-management command 345 includes at least one of a region identifier 365 and a pressure zone identifier 375 in the command qualifier 320. In yet another alternative example embodiment, the pressure-management command 345 further includes additional parameters 325. In one such alternative embodiment, the additional parameters 325 include a group-to-interval indicator 346. It should be appreciated that in yet another alternative embodiment, a plurality of such group-to-interval indicators 346 are included in the additional parameters 325 which is included in a pressure-management command 345. It should be appreciated that such group-to-interval indicators are typically used to assign a group of non-centralized irrigation controllers to a particular time interval during which that group of non-centralized controllers are to engage in an irrigation cycle.

FIG. 12 also depicts one example embodiment of a run-off-management command. In this example embodiment, a run-off-management command 350 comprises a command field 315 which is set to a value in order to distinguish the command as a run-off-management command 350. In this example embodiment, a run-off-management command 350 further comprises a command qualifier 320. In one alternative example embodiment, the command qualifier 320 comprises at least one of a region identifier 365 and a pressure zone identifier 375. Yet another alternative embodiment of a run-off-management command 350 further comprises additional parameters 325. In this alternative example embodiment, the additional parameters 325 include a maximum flow per-unit-time indicator 351. It should be appreciated that such a maximum flow per-unit-time indicator 351 is typically used to limit the amount of water applied during an irrigation cycle in order to provide adequate time for the water to penetrate the soil and thereby reduce water runoff. In some example embodiments, a non-centralized irrigation controller will respond to a maximum flow per-unit-time indicator by extending the length of an irrigation cycle and applying a duty cycle relative to the actual application of irrigation water, but this is just one illustrative embodiment and any suitable means may be utilized to limit the amount of irrigation to be applied over a particular interval of time. Accordingly, the claims appended hereto are not intended to be limited to any such examples disclosed herein.

FIG. 12 further illustrates one example embodiment of a time command 355. In order to enable a collection of non-centralized irrigation controllers to operate in a synchronized manner, it is necessary to establish a clock that is synchronized to a central clock. This synchronized clock, which in included in each of the non-centralized irrigation controllers, is used as a basis for timing operations within said controllers. Accordingly, one alternative example structure of a time command 355 includes a command field 315 which is used to distinguish the command as a time command. This is typically accomplished by setting the value of a command field 315 to a particular value thereby distinguishing the command as a time command. In one example alternative embodiment, a time command 355 further comprises a command qualifier 320 that includes a GMT offset value, which is a value in terms of hours offset from Greenwich meantime. In yet another alternative embodiment, the time command 355 further includes a time value 356, which reflects the time at the Prime Meridian (i.e. GMT). It should be appreciated that this particular structure of a time command 355 is merely one example of a command that may be used to convey time to a group of non-centralized irrigation controllers. In yet another alternative embodiment, a local time value is transmitted to each of the non-centralized irrigation controllers.

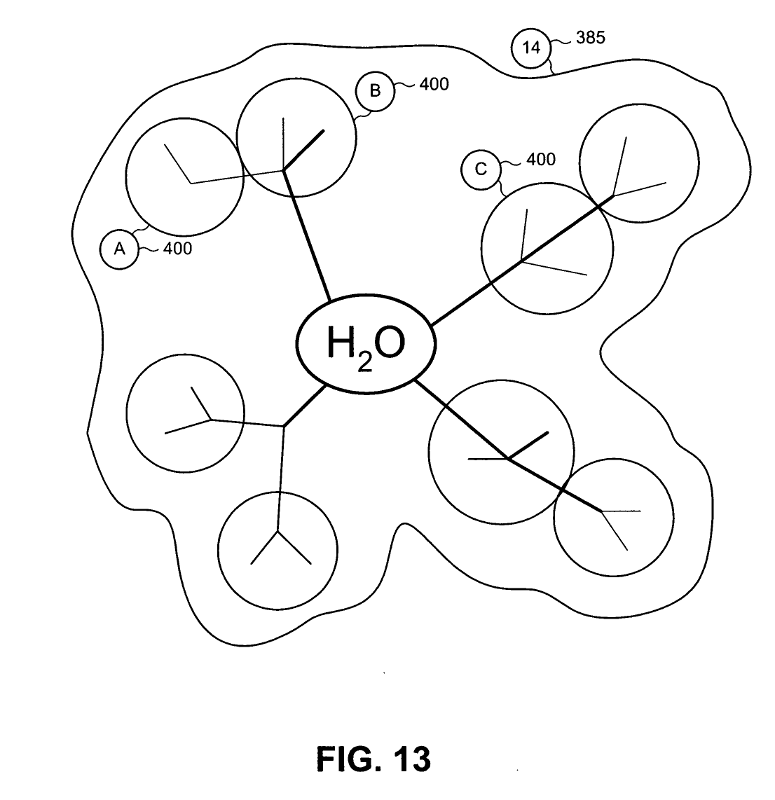

FIG. 13 is a pictorial illustration that depicts one illustrative use case where a particular water municipality is identified by a region identifier and said water municipality is further subdivided into pressure zones. It should further be noted that any structure of a particular water municipality or subdivision thereof is entirely variable and any particular structure or subdivision discussed within the scope of this disclosure is not intended to limit the claims appended hereto. In one illustrative use case, a region identifier 365 comprises a municipality ordinal number 385. In this illustrative use case, a particular water municipality is identified by an ordinal value of “14”. Again, the region identifier may be any suitable identifier and is not necessarily limited to an ordinal value, for example it may be an alphanumeric value, or any other suitable means of identifying a particular region. Any examples of a particular means for identifying a region or any specific values for identifying a region that may be set forth in this disclosure or any of the figures is not intended to limit the scope of the claims appended hereto and are presented in order to help clarify application of the method described herein.

FIG. 13 further illustrates that a particular region (for example a particular water municipality identified by an ordinal value of “14”), according to one variation of the present method, is further subdivided into pressure zones 395. Each such pressure zone 395 is identified by a pressure zone identifier 400. It should further be appreciated that a particular region, according to various alternative illustrative use cases, comprises at least one of a fire department identifier, a postal (e.g. ZIP) code, or any other geographic region suitable for a particular application and claims appended hereto are not intended to be limited in scope to any examples presented herein.

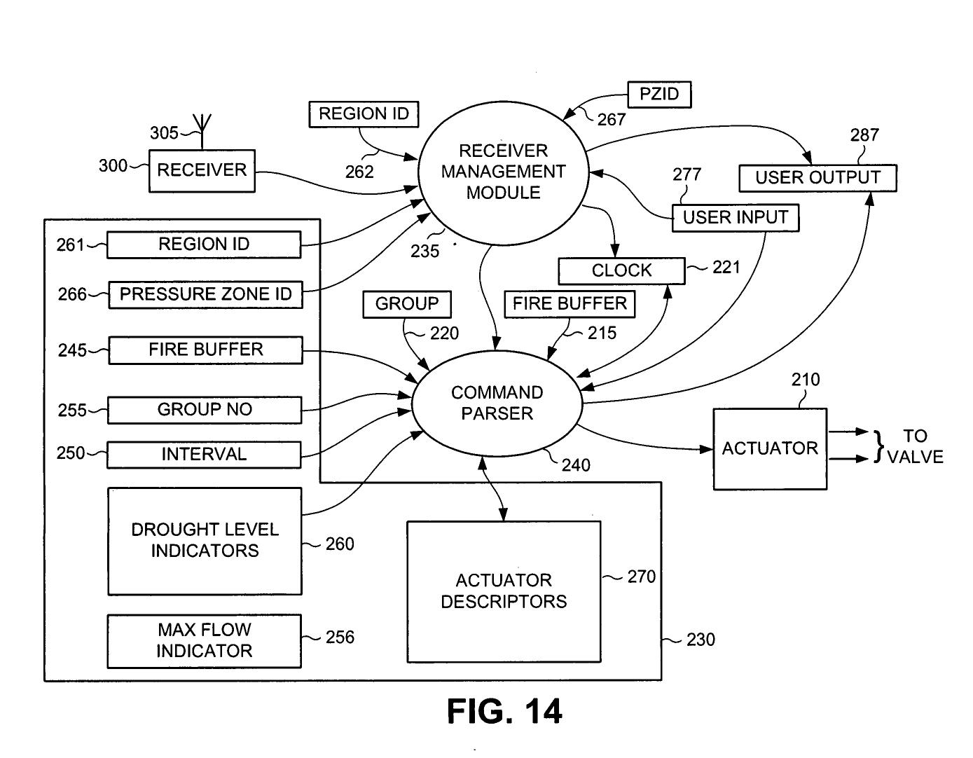

FIG. 14 is a data flow diagram that depicts the operation of various functional modules within a non-centralized irrigation controller. As already described, a non-centralized irrigation controller, according to various illustrative use cases, may be situated within a particular service region (e.g. a water municipality or fire district) and may be further situated within a particular pressure zone within such service region. Accordingly, each non-centralized irrigation controller must be able to determine within which particular service region it is situated and optionally within which particular pressures zone within such region it is situated. In operation, the processor 205 executes the receiver management module 235. In one example embodiment, the receiver management module 235, when executed by the processor 205, minimally causes the processor 205 to determine which particular service region and/or which particular pressures zone the non-centralized irrigation controller is situated in. In one example embodiment, the receiver management module 235, as it is executed by the processor 205, minimally causes the processor 205 to read a region identification signal 262 in order to determine which region the non-centralized irrigation controller is situated in. In one alternative embodiment, the receiver management module 235, as it is executed by the processor 205, further minimally causes the processor 205 to store the region identifier in a region identifier variable 261 stored in the memory 230. The receiver management module 235, as it is later executed by the processor 205, will minimally causes the processor 205 to refer to the region identification variable 261 in order to identify commands that are received by the receiver 300 and which must be passed onto the command parser 240. In yet another alternative example embodiment, the receiver management module 235, as it is executed by the processor 205, further minimally causes the processor 205 to read a pressures zone identifier signal 267. In one alternative embodiment, the receiver management module 235, when it is subsequently executed by the processor 205 in order to receive a command from the receiver 300, will further minimally causes the processor 205 to refer to the pressures zone identifier variable 266 stored in the memory 230 in order to determine if a particular command received from the receiver 300 should be directed to the command parser 240. It should be appreciated that, according to alternative example embodiment, the receiver management module 235 will, as it is executed by the processor 205, minimally cause the processor 205 to read at least one of the register identification signal 262 and the pressure zone identification signal 267 each time a command is received from the receiver 300. As such, the processor 205, as it continues to execute the receiver management module 235, will determine which commands received by the receiver should be forwarded to the command parser 240 using such “real-time” interrogation of at least one of the register identification signal 262 and the pressure zone identification signal 267. This, of course, is in contrast to other embodiments where at least one of a region identifier variable 261 and a pressure zone identifier 266 are stored in the memory 230 and are used by the processor 205 to determine which commands received from the receiver 300 ought to be directed to the command parser 240 as it continues to execute the receiver management module 235. In yet another alternative example embodiment, the receiver management module 235, as it is executed by the processor 205, minimally causes the processor to receive at least one of a region identifier and a zone identifier by means of the user input 277. In these alternative example embodiment, the receiver management module 235, as it is executed by the processor 205, further minimally causes the processor to store at least one of said region identifier and zone identifier in the region identifier variable 261 and the pressure zone identifier variable 266, respectively, either of which are stored in the memory 230.

FIG. 12 illustrates that many of the water management commands include a command qualifier which limits the target area of the command to at least a particular region, and in some alternative embodiments to a pressure zone within a region. Accordingly, as the processor 205 executes the receiver management module 235, the receiver management module 235 minimally causes the processor 205 to receive a command from the receiver 300. As the processor 205 continues to execute the receiver management module 235, said execution of the receiver management module 235 further minimally causes the processor to compare at least one of a region identifier 365 and a pressure zone identifier 375 included in the command qualifier 320 comprising a received command. The processor 205, as it executes the receiver management module 235, compares the command qualifier field 320 (e.g. a region identifier 365 and/or a pressures zone identifier 375) to a region identifier variable 261 stored in the memory 230 and, optionally, to a pressure zone identifier variable 266 that is also stored in the memory 230. In the case of a successful comparison, the receiver management module, as it is executed by the processor 205, further minimally causes the processor 205 to forward the received command to the command parser 240. The command parser 240, as it is executed by the processor 205, minimally causes the processor 205 to determine the nature of the command by means of examining the command field 315 included in the command received from the receiver management module 235. In some cases, as further illustrated in FIG. 12, a command includes additional parameters 325. The command parser 240, as it is executed by the processor 205, further minimally causes the processor to examine the content of the additional parameters 325 included in a command received from the receiver management module.

FIG. 14 also illustrates that, in one example alternative embodiment, the command parser 240 receives a command from the receiver module 235 when it is executed by the processor 205. In the case where the processor 205, as a result of continued execution of the command parser 240, determines a command comprises a fire-shut-off command 330, the command parser 240, as it is executed by the processor 205, further minimally causes the processor 205 to disable one or more actuators 210 when it receives a fire-shut-off command from the receiver management module 235. In yet another alternative example embodiment, the processor 205, as it executes the command parser 240, further minimally receives from the receiver management module 235 an additional parameter 325 for a fire-shut-off command 330. In this example alternative embodiment, the additional parameter 325 comprises a shut off time interval 331. Accordingly, the processor 205, as it executes the command parser 240, will disable one or more actuators 210 for a particular amount of time in accordance with the shut off time interval 331 included in the fire-shut-off command 330 that is received from the receiver management module 235.

In one example alternative embodiment, the command parser 240 receives a command from the receiver module 235 when it is executed by the processor 205. In the case where the processor 205, as a result of continued execution of the command parser 240, determines a command comprises a fire-activation command 335, the processor 205, as it continues to execute the command parser 240, is further minimally caused to first determine whether or not a particular non-centralized irrigation controller is situated in a fire buffer zone. In one alternative example embodiment, the processor 205 accomplishes this by further executing the command parser 240, which minimally causes the processor 205 to receive a fire buffer signal 215 in order to make such determination. In yet another alternative example embodiment, the processor 205, as it continues to execute the command parser 240, examines the state of a fire buffer zone Boolean variable 245 stored in the memory 230. In either case, the processor 205 continues to execute the command parser 240 and as a result of such continued execution of the command parser 240 the processor 205 determines that the non-centralized irrigation controller is situated in a fire buffer zone, the processor 205, under continued direction from the command parser 240 will activate one or more actuators 210. In one alternative example embodiment, the processor 205, as it continues to execute command parser 240, examines one or more actuators descriptors 270 stored in the memory 230. As the command parser 240 examines the one or more actuator descriptors 270, it will enable a particular actuator 210 in the event that the fire buffer Boolean 280 in the corresponding actuator descriptor 270, as determined by an actuator identifier 275, is set to a value of “true”. In yet another alternative example embodiment, the processor 205, as it executes the command parser 240, will receive additional parameters 325 from the receiver management module 235 that are associative with the fire-activation command. In one alternative example embodiment, the additional parameter 325 comprises a turn on time interval 336. In this event, the command parser 240, as it is executed by the processor 205, further minimally causes the processor 205 to enable a particular actuators 210 in accordance with the turn on time interval 336. In yet another alternative example embodiment, the command parser 240, as it is executed by the processor 205, further minimally causes the processor 205 to receive a volume indicator 337 from the receiver management module 235 as an additional parameter 325 to the fire-activation command 335. In this alternative embodiment, the processor 205, as it continues to execute the command parser 240, is further minimally caused by the command parser 240 to enable a particular actuator 210 in a manner so as to apply a particular volume of water for a particular irrigation zone controlled by a particular actuator 210. In this alternative example embodiment, the command parser 240, as it is executed by the processor 205, further minimally causes the processor 205 to examine the actuators descriptors 270 that are stored in the memory 230. In this case, the command parser 240 further minimally causes the processor 205 to examine a flow rate 290 for a particular actuator as depicted in an actuator descriptor 270 for a particular actuator. Using the flow rate 290, the processor 205, as it continues to execute command parser 240, is further minimally caused to enable a particular actuator for a particular amount of time so as to apply a particular volume of water based upon the volume indicator 337 and the flow rate 290 for a particular actuator.

In one alternative example embodiment, to the receiver management module 235 receives a drought management command from the receiver 300. As the processor 205 continues to execute the receiver management module 235, is further minimally caused to determine whether or not a drought management command is directed to a particular region and/or pressure zone. In the event that the drought management command is in fact targeted to the non-centralized irrigation controller, and the processor 205, as it continues to execute the receiver management module 235, will direct additional parameters in the drought management command to the command parser 240. Upon receiving the additional parameters, which in one example embodiment comprises one or more drought level indicators, to the command parser 240, as it is further executed by the processor 205, minimally causes the processor 205 to store the one or more drought level indicators in one or more corresponding drought level indicator variables 260, which are stored in the memory 230.

When the command parser 240, as it is executed by the processor 205, determines that is time to engage in any irrigation cycle, the command parser 240 will further minimally caused the processor to retrieve one or more drought level indicators from corresponding variables 260 stored in the memory. The processor 205, as it continues to execute the command parser 240, will also consult a table 270 of actuator descriptors. The processor 205 will then match a particular plant type 285 included in the various actuator descriptors in order to determine which drought level indicator is applicable to a particular actuator. Accordingly, the processor 205, as it continues to execute the command parser 240, will control a particular actuator 210 by reducing of the amount of water to be applied in accordance with the drought level indicator.

In yet another alternative example embodiment, a drought management command will included a single drought level indicator. In this case, to the command parser 240, as it is executed by the processor 205, will minimally caused the processor to store to the single drought level indicator in a drought level indicator variables 260 stored in the memory 230. Accordingly, the command parser 240 of this alternative embodiment will minimally cause the processor 205 to reduce the activity level of one or more actuators 210 in accordance with the single drought level indicator stored in the drought level indicator variable 260, which is stored in the memory 230.

In yet another alternative example embodiment, the command parser 240, as it is executed by the processor 205, receives a pressure management command from the receiver management module 235. In this case, the receiver management module 235, as it is executed by the processor 205, further minimally causes the processor 205 to extract a group-to-interval indicator from the pressure management command received from the receiver 300. Accordingly, the group-to-interval indicator is directed to the command parser 240. As the processor 205 continues to execute the command parser 240, the processor 205 will store the “group” portion of the group-to-interval indicator in the group number variable 255 stored in the memory 230. With continued execution of the command parser 240, the processor 205 is further minimally caused to store the “interval” portion the group-to-interval indicator in the interval variable 215, which is also stored in the memory 230. As the command parser 240 is executed, the processor 205 is further minimally caused to consult the clock 221 in order to determine a current time interval. When the current time interval is substantially equivalent to the value stored in the interval variable 215 stored in the memory 230, the processor 205 is further minimally caused to engage in an irrigation cycle.

In one alternative example embodiment, the processor 205, as it continues to execute the command parser 240, is minimally caused to recognize a run-off command. According to this example embodiment, the receiver management module 235, when executed by the processor 205, minimally causes the processor 205 to receive said run-off command from the receiver 300 and further causes the processor 205 to determine whether or not the run-off management command is targeted for a particular region and/or pressure zone. In this event, the processor 205, as it continues to execute the receiver management module 235, is further minimally caused to receive a maximum flow indicator as an additional parameter included in the run-off the management command. The processor 205, as it continues to execute the receiver management module 235, then directs the maximum flow indicator to the command parser 240. The processor 205, then continues to execute the command parser 240. The command parser 240 further minimally causes the processor 205 to store the maximum flow indicator in a maximum flow indicator variable 256, which is stored in the memory 230. When the processor 205, through continued execution of the command parser 240, determines that it must engage in an irrigation cycle, the processor 205, it will determine the amount of flow per unit time for a particular actuator 210 by consulting a corresponding actuator descriptor 270 that is stored in the memory 230. The processor 205, according to this example of embodiment and through continued execution of the command parser 240, is further minimally caused to cycle a particular actuator 210 over a particular period of time in order to comply with the value stored in the maximum flow indicator variable 256, which is stored in the memory 230.

In yet another alternative embodiment, the processor 205, as it continues to execute the receiver management module 235, is minimally caused to recognize a time command which is received from the receiver 300. In this event, the processor 205 retrieves a time value from the time command and is further minimally caused to store the time value in the clock 221 as it continues to execute the receiver management module 235.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for emergency remote control of irrigation comprising:
monitoring a communications channel;
receiving from the communications channel a water management command including at least one of a fire-shut-off command, a fire-activation-command, a drought-management-command, a pressure-management-command and a run-off-management-command; and controlling by an automatic means one or more irrigation zones in a non-centralized irrigation controller according to the received command.

2. The method of claim 1 wherein the step of controlling by automatic means one or more irrigation zones when a fire-shut-off command is received comprises at least one of the steps of disabling all irrigation in the non-centralized irrigation controller, disabling all irrigation in the non-centralized irrigation controller for a specified interval of time, interrupting power flow to the non-centralized irrigation controller and interrupting power flow to the non-centralized irrigation controller for a specified interval of time.

3. The method of claim 1 wherein the step of controlling by automatic means one or more irrigation zones when a fire-activation-command is received includes at least one of the steps of causing application of water to one or more particular irrigation zones controlled by a non-centralized irrigation controller and causing application of water to one or more particular irrigation zones controlled by a non-centralized irrigation controller for a particular interval of time when the fire-activation-command is received by a particular non-centralized irrigation controller that is disposed in a fire buffer area.

4. The method of claim 1 wherein the step of controlling by automatic means one or more irrigation zones when a fire-activation-command is received comprises enabling power flow to one or more valve actuators when the fire-activation-command is received by a particular non-centralized irrigation controller that is disposed in a fire buffer area.

5. The method of claim 1 wherein the step of receiving a drought-management-command comprises receiving a drought-level-indicator and wherein the step of controlling by an automatic means one or more irrigation zones in a non-centralized irrigation controller comprises the step of reducing application of water according to the drought-level-indicator.

6. The method of claim 1 wherein the step of receiving a drought-management-command comprises receiving a plurality of drought-level-indicators for a plurality of plant value levels and wherein the step of controlling by an automatic means one or more irrigation zones in a non-centralized irrigation controller comprises the step of reducing the application of water to a plurality of different plant types according to the received plurality of drought-level-indicators for a plurality of plant value levels.

7. The method of claim 1 further comprising:
assigning a non-centralized irrigation controller to one of a plurality of controller groups; and
shifting a peak-utilization window for the non-centralized controller according to the received pressure-management-command.

8. The method of claim 7 wherein the step of shifting a peak-utilization window comprises shifting a peak-utilization window according to which group the non-centralized irrigation controller is assigned to at least within a 24 hour interval of time or according to a selection of watering days within a recurring period of time.

9. The method of claim 7 further comprising:
receiving a system time indicator from the communications channel; and
synchronizing an internal clock in the non-centralized irrigation controller according to the system time indicator and wherein shifting a peak-utilization window comprises shifting a peak-utilization window according to the internal clock and according to which group the non-centralized irrigation controller is assigned to.

10. A non-centralized irrigation controller comprising:
one or more processors for executing an instruction sequence;
memory for storing one or more instruction sequences;
receiver for receiving water management commands;
one or more actuator outputs for controlling water valves; and
one or more instruction sequences stored in the memory including:
receiver management module that, when executed the processor, causes the processor to receive water management commands including at least one of a fire-shut-off command, a fire-activation-command, a drought-management-command, a pressure-management-command and a run-off-management command; and command parser module that, when executed the processor, causes the processor to control the actuator outputs in response to a received water management command.

11. The non-centralized irrigation controller of claim 10 wherein the command management module, when executed by the processor, causes the processor to disable one or more of the actuator outputs when the processor, as it executes the command management module, recognizes a fire-shut-off command.

12. The non-centralized irrigation controller of claim 10 wherein the command management module, when executed by the processor, causes the processor to disable one or more of the actuator outputs for a specified interval of time when the processor, as it executes the command management module, recognizes a fire-shut-off command.

13. The non-centralized irrigation controller of claim 10 further comprising at least one of a fire buffer signal input and a fire buffer indicator stored in the memory and wherein the command management module, when executed by the processor, causes the processor to enable one or more of the actuator outputs when the processor, as it executes the command management module, recognizes a fire-activation-command and further recognizes that the non-centralized irrigation controller is disposed in a fire buffer area either by reading the fire buffer signal from the fire buffer signal input or by examining the fire buffer indicator stored in the memory.

14. The non-centralized irrigation controller of claim 10 further comprising at least one of a fire buffer signal input and a fire buffer indicator stored in the memory and wherein the command management module, when executed by the processor, causes the processor to enable one or more of the actuator outputs for a particular period of time when the processor, as it executes the command management module, recognizes a fire-activation-command and further recognizes that the non-centralized irrigation controller is disposed in a fire buffer area either by reading the fire buffer signal from the fire buffer signal input or by examining the fire buffer indicator stored in the memory.

15. The non-centralized irrigation controller of claim 10 further comprising at least one of a fire buffer signal input and a fire buffer indicator stored in the memory and wherein the command management module, when executed by the processor, causes the processor to enable one or more of the actuator outputs for a particular period of time so as to apply a particular volume of water when the processor, as it executes the command management module, recognizes a fire-activation-command and further recognizes that the non-centralized irrigation controller is disposed in a fire buffer area either by reading the fire buffer signal from the fire buffer signal input or by examining the fire buffer indicator stored in the memory.

16. The non-centralized irrigation controller of claim 10 wherein the command management module, when executed by the processor, causes the processor to extract a drought-level-indicator from a drought-management-command and further causes the processor to enable one or more of the actuator outputs for a specified interval of time according to the drought-level-indicator.

17. The non-centralized irrigation controller of claim 10 wherein the command management module, when executed by the processor, causes the processor to extract a plurality of drought-level-indicators that correspond to different plant types from one or more drought-management-commands and further causes the processor to enable one or more of the actuator outputs for a specified interval of time wherein the specified interval of time for different actuators is determined according to one of the plurality of drought-level-indicator.

18. The non-centralized irrigation controller of claim 10 further comprising at least one of a group identification signal input and a controller group indicator stored in the memory and wherein the command management module, when executed by the processor, causes the processor to determine a controller group identifier either by reading a value from the group identification signal input or by reading a value from the controller group indicator and further causes the processor to extract an interval identifier from a pressure-management-command wherein said interval identifier corresponds to the controller group identifier and further causes the processor to enable one or more of the actuator outputs during an interval of time as determined according to the interval identifier.

19. The non-centralized irrigation controller of claim 18 wherein the interval identifier comprises at least one of an interval identifier for a time interval within a 24 hour period and an interval identifier for a time interval within a selection of watering days in a recurring interval of time.

20. A non-centralized irrigation controller comprising:
one or more actuator outputs for controlling water valves;
receiver for receiving water management commands including at least one of a fire-shut-off command, a fire-activation-command, a drought-management-command, a pressure-management-command and a run-off-management command; and
controller that activates or deactivates one or more of said actuator outputs in accordance with a received water management command.
